(19) United States
(12) Patent Application Publication
(10) Pub. No.: US 2006/0285654 A1
(43) Pub. Date: Dec. 21, 2006

(54) System and method for performing automatic dubbing on an audio-visual stream

(76) Inventors: Jan Alexis Daniel Nesvadba, Eindhoven (NL); Dirk Jeroen Breebaart, Veldhoven (NL); Martin Franciscus Mc Kinney, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/552,764

(22) PCT Filed: Apr. 12, 2004
(86) PCT No.: PCT/IB04/01065

§ 371 Date: Aug. 3, 2006

(30) Foreign Application Priority Data
Apr. 14, 2003 (EP) 03101004.4

(51) Int. Cl. H04M 1/64

(52) U.S. Cl. 379/67.1

(57) ABSTRACT

The invention describes a system (1) for performing automatic dubbing on an incoming audio-visual stream (2). The system (1) comprises means (3, 7) for identifying the speech content in the incoming audio-visual stream (2), a speech-to-text converter (13) for converting the speech content into a digital text format (14), a translating system (15) for translating the digital text (14) into another language or dialect; a speech synthesizer (19) for synthesizing the translated text (18) into a speech output (21), and a synchronizing system (9, 12, 22, 23, 26, 31, 33, 34, 35) for synchronizing the speech output (21) to an outgoing audio-visual stream (28). Moreover the invention describes an appropriate method for performing automatic dubbing on an audio-visual stream (2).

This invention relates in general to a system and method for performing automatic dubbing on an audio-visual stream, and, in particular, to a system and method for providing automatic dubbing in an audio-visual device.

Audio-visual streams observed by a viewer are, for example, television programs broadcast in the language native to the country of broadcast. Moreover, an audio-visual stream may originate from DVD, video, or any other appropriate source, and may consist of video, speech, music, sound effects and other contents. An audio-visual device can be, for example, a television set, a DVD player, VCR, or a multimedia system. In the case of foreign-language films, subtitles—also known as open captions—can be integrated into the audio-visual stream by keying the captions into the video frames prior to broadcast. It is also possible to perform voice-dubbing on foreign-language films to the native language in a dubbing studio before broadcasting the television program. Here, the original screenplay is first translated into the target language, and the translated text is then read by a professional speaker or voice talent. The new speech content is then synchronized into the audio-visual stream. For programs featuring well-known actors, the dubbing studios may employ speakers whose speech profiles most closely match those of the original speech content. In Europe, videos are usually available in one language only, either in the original first language or dubbed into a second language. Videos for the European market are relatively seldom supplied with open captions. DVDs are commonly available with a second language accompanying the original speech content, and are occasionally available with more than two languages. The viewer can switch between languages as desired and may also have the option of displaying subtitles in one or more of the languages.

Dubbing with professional voice talent has the disadvantage of being limited, owing to the expense involved, to a few majority languages. Because of the effort and expense involved, only a relatively small proportion of all programs can be dubbed. Programs such as news coverage, talk shows or live broadcasts are usually not dubbed at all. Captioning is also limited to the more popular languages with a large target audience such as English, and to languages that use the Roman font. Languages like Chinese, Japanese, Arabic and Russian use different fonts and cannot easily be presented in the form of captions. This means that viewers whose native language is other than the broadcast language have a very limited choice of programs in their own language. Other native-language viewers wishing to augment their foreign-language studies by watching and listening to audio-visual programs are also limited in their choice of viewing material.

Therefore, an object of the present invention is to provide a system and a method which can be used to provide simple and cost-effective dubbing on an audio-visual stream.

The present invention provides a system for performing automatic dubbing on an audio-visual stream, wherein the system comprises means for identifying the speech content in the incoming audio-visual stream, a speech-to-text converter for converting the speech content into a digital text format, a translating system for translating the digital text into another language or dialect; a speech synthesizer for synthesizing the translated text into a speech output and a synchronizing system for synchronizing the speech output to an outgoing audio-visual stream.

An appropriate method for automatic dubbing of an audio-visual stream comprises identifying the speech content in the incoming audio-visual stream, converting the speech content into a digital text format, translating the digital text into another language or dialect, converting the translated text into a speech output and synchronizing the speech output to an outgoing audio-visual stream.

The process of introducing a dubbed speech content in this way can be effected centrally, for example in a television studio before broadcasting the audio-visual stream, or locally, for example in a multimedia device in the viewer's home. The present invention has the advantage of providing a system of supplying an audience with an audio-visual stream dubbed in the language of choice.

The audio-visual stream may comprise both video and audio contents encoded in separate tracks, where the audio content may also contain the speech content. The speech content may be located on a dedicated track or may have to be filtered out of a track containing music and sound effects along with the speech. A suitable means for identifying such speech content, making use of existing technology, may comprise specialised filters and/or software, and may either make a duplicate of the identified speech content or extract it from the audio-visual stream. Thereafter the speech content or speech stream can be converted into a digital text format by using existing speech recognition technology. The digital text format is translated by an existing translation system into another language or dialect. The resulting translated digital text is synthesized to produce a speech audio output which is then inserted as speech content into the audio-visual stream in such a way that the original speech content can be replaced by or overlaid with the dubbed speech, leaving the other audio content i.e. music, sound effects etc., unchanged. By combining existing technologies in this novel way, the present invention can be realised very easily and offers a low-cost alternative to hiring expensive speakers to perform speech dubbing.

The dependent claims disclose particularly advantageous embodiments and features of the invention.

In a particularly advantageous embodiment of the invention, a voice profiler analyses the speech content and generates a voice profile for the speech. The speech content may contain one or more voices, speaking sequentially or simultaneously, for which a voice profile is generated. Information regarding pitch, formants, harmonics, temporal structure and other qualities is used to create the voice profile, which may remain steady or change as the speech stream progresses, and which serves to reproduce the quality of the original speech. The voice profile is used at a later stage for authentic voice synthesis of the translated speech content. This particularly advantageous embodiment of the invention ensures that the unique voice traits of well-known actors are reproduced in the dubbed audio-visual stream.

In another preferred embodiment of the invention, a source of time data is used to generate timing information which is assigned to the speech stream and to the remaining audio and/or video streams so as to indicate the temporal relationship between the two streams. The source of time data may be a type of clock, or may be a device which reads time data already encoded in the audio-visual stream. Marking the speech stream and the remaining audio and/or video streams in this manner provides an easy way of synchronizing the dubbed speech stream back into the other streams at a later stage. The timing information can also be used to compensate for delays incurred on the speech stream, for example in converting the speech to text or in creating the voice profile. The timing information on the speech stream may be propagated to all derivatives of the speech stream, for example the digital text, the translated digital text, and the output of voice synthesis. The timing information can thus be used to identify the beginning and end, and therefore the duration, of a particular vocal utterance, so that the duration and position of the synthesized voice output can be matched to the position of the original vocal utterance on the audio-visual stream.

In another arrangement of the invention, the maximum effort to be expended on translation and dubbing can be specified, for example, by selecting between “normal” or “high quality” modes. The system then determines the time available for translating and dubbing the speech content, and configures the speech-to-text converter and the translation system accordingly. The audio-visual stream can thus be viewed with a minimum time lag, which may be desirable in the case of live news coverage; or with a greater time lag, allowing the automatic dubbing system to achieve best quality of translation and voice synthesis which may be particularly desirable in the case of motion picture films, documentaries, and similar productions.

Furthermore, the system may function without the insertion of additional timing information, by using pre-determined fixed delays for the different streams.

Another preferred feature of the invention is a translation system for translating the digital text format into a different language. Therefore, the translation system can comprise a translation program and one or more language and/or dialect databases from which the viewer can select one of the available languages or dialects into which the speech is then translated.

A further embodiment of the invention includes an open-caption generator which converts the digital text into a format suitable for open captioning. The digital text may be the original digital text corresponding to the original speech content, and/or may be an output of the translation system. Timing information accompanying the digital text can be used to position the open captions so that they are made visible to the viewer at the appropriate position in the audio-visual stream. The viewer can specify if the open captions are to be displayed, and in which language—the original language and/or the translated language—they are to be displayed. This feature would be of particular use to viewers wishing to learn a foreign language, either by hearing speech content in the foreign language and reading the accompanying sub-titles in their own native language, or by listening to the speech content in their native language and reading the accompanying subtitles as foreign-language text.

The automatic dubbing system can be integrated in or an extension of any audio-visual device, for example a television set, DVD player or VCR, in which case the viewer has a means of entering requests via a user interface.

Equally, the automatic dubbing system may be realised centrally, for example in a television broadcasting station, where sufficient bandwidth may allow cost-effective broadcasting of the audio-visual stream with a plurality of dubbed speech contents and/or open captions.

The speech-to-text converter, voice profile generator, translation program, language/dialect databases, speech synthesizer and open-caption generator can be distributed over several intelligent processor or IP blocks allowing smart distribution of the tasks according to the capabilities of the IP blocks. This intelligent task distribution will save processing power and perform the task in as short a time as possible.

Other objects and features of the present invention will become apparent from the following detailed descriptions considered in conjunction with the accompanying drawings. It is to be understood, however, that the drawings are designed solely for the purposes of illustration and not as a definition of the limits of the invention, for which reference should be made to the appended claims.

In the drawings, wherein like reference characters denote the same lements throughout:

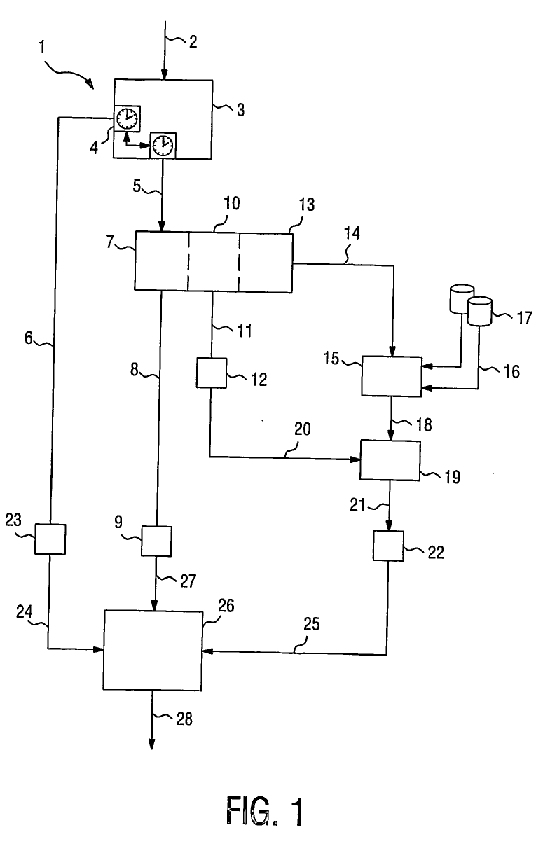

FIG. 1 is a schematic block diagram of a system for automatic dubbing in accordance with a first embodiment of the present invention;

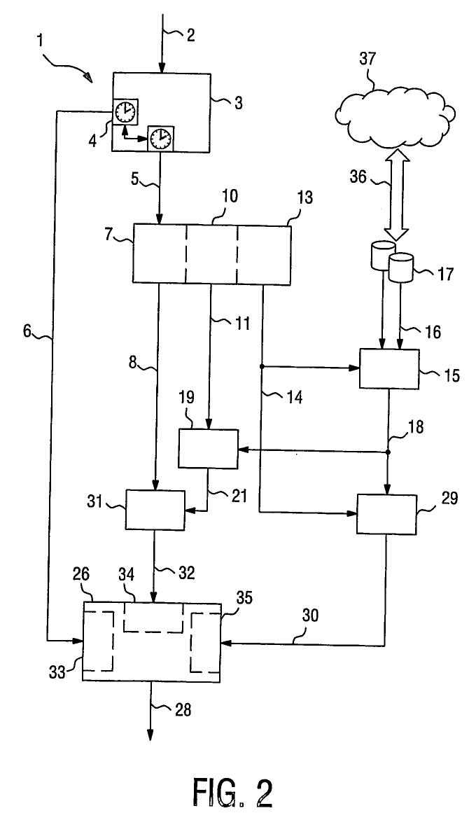

FIG. 2 is a schematic block diagram of a system for automatic dubbing in accordance with a second embodiment of the present invention.

In the description of the following figures, which do not exclude other possible realisations of the invention, the system is shown as part of a user device, for example a TV. For the sake of clarity, the interface between the viewer (user) and the present invention has not been included in the diagrams. It is understood, however, that the system includes a means of interpreting commands issued by the viewer in the usual manner of a user interface and also means for outputting the audio-visual stream, for example, a TV screen and loudspeakers.

FIG. 1 shows an automatic dubbing system 1 in which an audio/video splitter 3 separates the audio content 5 of an incoming audio-visual stream 2 from the video content 6. A source of time data 4 assigns timing information to the audio 5 and video 6 streams.

The audio stream 5 is directed to a speech extractor 7, which generates a copy of the speech content and diverts the remaining audio content 8 to a delay element 9 where it is stored, unchanged, until required at a later stage. The speech content is directed to a voice profiler 10 which generates a voice profile 11 for the speech stream and stores this along with timing information in a delay element 12 until required at a later stage. The speech stream is passed to a speech-to-text converter 13 where it is converted into speech text 14 in a digital format. The speech extractor 7, the voice profiler 10, and the speech-to-text converter 13 may be separate devices but are more usually realised as a single device, for example a complex speech recognition system.

The speech text 14 is then directed to a translator 15 which uses language information 16 supplied by a language database 17 to produce translated speech text 18.

The translated speech text 18 is directed to a speech synthesis module 19 which uses the delayed voice profile 20 to synthesize the translated speech text 18 into a speech audio stream 21.

Delay elements 22, 23 are used to compensate for timing discrepancies on the video stream 6 and the translated speech audio stream 21. The delayed video stream 24, the delayed translated speech audio stream 25 and the delayed audio content 27 are input to an audio/video combiner 26 which synchronizes the three input streams 24, 25, 27 according to their accompanying timing information, and where the original speech content in the audio stream 27 can be overlaid with or replaced by the translated audio 25, leaving the non-speech content of the original audio stream 27 unchanged. The output of the audio/video combiner 26 is the dubbed outgoing audio-visual stream 28.

FIG. 2 shows an automatic dubbing system 1 in which a speech content is identified in the audio content 5 of an incoming audio-visual stream 2 and processed in a similar manner to that described in FIG. 1 to produce speech text 14 in a digital format. In this case, however, the speech content is diverted from the remaining audio stream 8.

In this example, however, open captions are generated for inclusion in the audio-visual output stream 28. As described in FIG. 1, the speech text 14 is directed to a translator 15, which translates the speech text 14 into a second language, using information 16 obtained from a language database 17. The language database 17 can be updated as required by downloading up-to-date language information 36 from the internet 37 via a suitable connection.

The translated speech text 18 is passed to the speech synthesis module 19 and also to an open-captioning module 29, where the original speech text 14 and/or the translated speech text 18, according to a selection made by the viewer, is converted to an output 30 in a format suitable for presentation of open captions. The speech synthesis module 19 generates speech audio 21 using the voice profile 11 and the translated speech text 18.

An audio combiner 31 combines the synthesized speech output 21 with the remaining audio stream 8 to provide a synchronized audio output 32. An audio/video combiner 26, synchronizes the audio stream 32, the video stream 6, and the open captions 30 by using buffers 33, 34, 35 to delay the three inputs 32, 6, 30 by appropriate lengths of time to produce an output audio-visual stream 28.

Although the present invention has been disclosed in the form of preferred embodiments and variations thereon, it will be understood that numerous additional modifications and variations could be made thereto without departing from the scope of the invention.

For example, the translation tools and the language databases can be updated or replaced as desired by downloading new versions from the internet. In this way, the automatic dubbing system can make the most of current developments in electronic translating, and can keep up-to-date with developments in the languages of choice, such as new buzz-words and product names. Also, speech profiles and/or speaker models for the automatic speech recognition for the voices of well-known actors could be stored in a memory and updated as required, for example, by downloading from the internet. If future technology allows such information about the actors featured in motion picture films to be encoded in the audio-visual stream, the individual speaker model for the actors could be applied to the automatic speech recognition and the correct speech profiles could be assigned to the synthesis of the actors' voices in the language of choice. The automatic dubbing system would then only have to generate profiles for the less well-know actors.

Additionally, the system may employ a method of selecting between different voices in the speech content of the audio-visual stream. Then, in the case of films featuring more than one language, the user can specify which of the languages are to be translated and dubbed, leaving the speech content in the remaining languages unaffected.

The present invention can also be used as a powerful learning tool. For example, the output of the speech-to-text converter can be directed to more than one translator, so that the text can be converted into more than one language, selected from the available language databases. The translated text streams can be further directed to a plurality of speech synthesizers, to output the speech content in several languages. Channelling the synchronised speech output to several audio outputs, e.g. through headphones, can allow several viewers to watch the same program and for each viewer to hear it in a different language. This embodiment would be of particular use in language schools where various languages are being taught to the students, or in museums, where audio-visual information is presented to viewers of various nationalities.

For the sake of clarity, throughout this application, it is to be understood that the use of “a” or “an” does not exclude a plurality, and “comprising” does not exclude other steps or elements.

1. A system (1) for performing automatic dubbing on an incoming audio-visual stream (2), said system (1) comprising: means (3, 7) for identifying the speech content in the audio-visual stream (2); a speech-to-text converter (13) for converting the speech content into a digital text format (14); a translating system (15) for translating the digital text (14) into another language or dialect; a speech synthesizer (19) for synthesizing the translated text (18) into a speech output (21); and a synchronizing system (9, 12, 22, 23, 26, 31, 33, 34, 35) for synchronizing the speech output (21) to an outgoing audio-visual stream (28).

2. The system (1) of claim 1, containing a voice profiler (10) for generating voice profiles (11) for the speech content and for allocating the appropriate voice profile (11) to the translated text (14) for speech output synthesis.

3. The system (1) according to claim 1, wherein the system (1) contains a source of time data (4) for the allocation of timing information to the audio and video contents (4, 5) for later synchronisation of these contents.

4. The system (1) according to claim 1, wherein the translation system (15) contains a language database (17) with a plurality of different languages and/or dialects and means for selection of a language or dialect from this database (17) into which the digital text (14) is to be translated.

5. The system (1) according to claim 1, wherein the system (1) contains an open-caption generator (29) for the creation of open captions (30) using the digital text (14) and/or the translated digital text (18), for inclusion in an outgoing audio-visual stream (28).

6. An audio-visual device comprising a system (1) according to claim 1.

7. A method for automatic dubbing of an incoming audio-visual stream (2), which method comprises: identifying the speech content in the audio-visual stream (2); converting the speech content into a digital text format (14); translating the digital text (14) into another language or dialect; converting the translated text (18) into a speech output (21); synchronizing the speech output (21) to an outgoing audio-visual stream (28).

8. The method of claim 7, wherein voice profiles (11) for the speech content are generated and allocated to the appropriate translated text (18) in the synthesis of speech output (21).

9. The method of claim 7, wherein a copy of the speech content is diverted from the audio-visual stream (2) or from an audio content of the audio-visual stream (2).

10. The method of claim 7, wherein the speech content in the audio-visual stream (2) is separated from the remaining audio-visual stream or from an remaining audio content of the audio-visual stream (2).

11. The method according to claim 1, wherein an audio/video combiner (26) inserts the speech output (21) into the outgoing audio-visual stream (28), replacing the original speech content.

12. The method according to claim 1, wherein an audio/video combiner (26) overlays the speech output (21) into the outgoing audio-visual stream (28).
